(19) United States
(12) Patent Application Publication
(10) Pub. No.: US 2007/0210242 A1
(43) Pub. Date: Sep. 13, 2007

(54) Optical sensor module

(75) Inventor: Jae-Geol Cho, Suwon-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/714,978

(22) Filed: Mar. 7, 2007

(30) Foreign Application Priority Data
Mar. 9, 2006 (KR) 2006-22231

(51) Int. Cl. G06M 7/00

(52) U.S. Cl. 250/221

(57) ABSTRACT

Disclosed is an optical sensor module for measuring organic constituents of a portion of a living body, which comprises at least a light source for generating a light; an optical sensor having a light reception surface for detecting the intensity of a light resulting from the interactance of the light from the light source with the organic constituents; and a light guide having a first light-transmitting surface to contact a living body portion and a second light-transmitting surface positioned opposite the first surface for transmitting the light from the light source uniformly across into the living body portion, the light reception surface of the optical sensor being exposed to the first surface.

### CLAIM OF PRIORITY

This application claims priority under 35 U.S.C. § 119 to an application entitled “Optical Sensor Module” filed in the Korean Intellectual Property Office on Mar. 9, 2006 and assigned Serial No. 2006-22231, the contents of which are incorporated herein by reference.

### BACKGROUND OF THE INVENTION

1. Field of the Invention

The present invention relates to a sensor module for detecting biological signals, and more particularly to an optical sensor module for measuring the composition of a living body by using a light interacting with a body.

2. Description of the Related Art

Recently, varieties of optical sensor modules, for measuring the organic constituents of a living body such as body fat, pulse, and blood flow rate, have been utilized for checking the health state and exercise level of people. Such an optical sensor module utilizes optical interactance principles, according to which a light penetrating a desired part of the body is multiply-scattered back to the optical sensor by interacting with the body's organic constituents, and the intensity of the returning light is measured to determine the characteristics of the body such as the thickness and percentage of the body fat, pulse and blood flow rate.

The body fat measurement technology using light waves has been already commercially utilized for medical and aesthetic purposes, and two closely related patents are U.S. Pat. No. 4,633,087 to Rosenthal et al and entitled “Near Infrared Apparatus For Measurement of Organic Constituents of Material” and U.S. Pat. No. 4,850,365 to Robert D. Rosenthal entitled “Near-Infrared Apparatus for Measurement of Organic Constituents of Material”. Such conventional optical sensor modules for measuring organic constituents of a living body transmit near-infrared radiation of a predetermined wavelength into a target portion of the body to achieve the optical interactance between the body and the near-infrared radiation. Namely, the near-infrared radiation interacts with the constituents of the target portion, thereby being scattered back to the optical sensor, and the intensity of the scattered-back radiation is measured to determine the amount of the body fat. To this end, U.S. Pat. No. 4,633,087 teaches at least two different wavelengths and U.S. Pat. No. 4,850,365 teaches a single wavelength for measuring only the body fat. These patents also employ regression analysis considering the wavelength used for measuring organic constituents of the body along with various parameters such as the weight age, sex, and stature of the subject body.

A conventional optical sensor module comprises a plurality of light sources for illuminating a desired portion of a subject body with uniform radiation, each such light source being structured as a short probe cylinder having an end contacting the desired portion of the subject body and having a diameter less than its length. This causes the light waves to become uniformly radiated at the subject surface through traveling a predetermined distance. FIG. 1 illustrates a conventional optical sensor module contacting a body surface, as represented by reference numeral 100, for measuring organic constituents of a living body such as the pulse and oxygen saturation of the blood. The optical sensor module 120 comprises a light source 121 and an optical sensor 122 arranged in a housing 123, the optical sensor 122 detecting the intensity of the light being scattered back by the body.

A second conventional optical sensor module, illustrated in FIG. 2, comprises light sources 121a′ and 121b′ arranged in their respective mounting holes 123′ for generating light waves to illuminate the body, an optical sensor 122′ for detecting the intensity of the light being scattered back by the body, and a housing 124′ for forming the mounting holes. The second optical sensor module is designed to become larger in its length than in its diameter contacting the body, and to have the light sources 121a′ and 121b′ symmetrically arranged about the optical sensor 122′, so as to cause the light waves to be uniformly radiated upon the body surface. The sensor module as shown in FIG. 2 is a miniaturization of the probe-type sensor module as disclosed in the U.S. Pat. No. 4,633,087 and U.S. Pat. No. 4,850,365, wherein the length of the probe is larger than the diameter in order to secure accurate and repeatable measurements. However, it is difficult to achieve such a structure to a portable device.

### SUMMARY OF THE INVENTION

The present invention provides a compact optical sensor module for measuring organic constituents of a living body.

According to an aspect of the present invention, an optical sensor module for measuring organic constituents of a portion of a living body, comprises at least a light source for generating a light; an optical sensor having a light reception surface for measuring the intensity of a light resulting from the interactance of the light from the light source with the organic constituents; and a light guide having a first light-transmitting surface contacting the portion of the living body and a second light-transmitting surface positioned opposite the first light-transmitting surface for dispersing the light from the light source uniformly across at least a part of the first light-transmitting surface to be transmitted therethrough into the living body portion, the light reception surface of the optical sensor being exposed to the first light-transmitting surface.

### BRIEF DESCRIPTION OF THE DRAWINGS

The above and other features and advantages of the present invention will become more apparent from the following detailed description when taken in conjunction with the accompanying drawing in which:

FIG. 1 illustrates a schematic diagram of a first conventional optical sensor module for measuring organic constituents of a living body;

FIG. 2 illustrates a perspective view of a second conventional optical sensor module;

FIG. 3A illustrates a schematic plane view of an optical sensor module according to a first embodiment of the present invention;

FIG. 3B illustrates a cross sectional view of the optical sensor module as shown in FIG. 3A;

FIG. 4A illustrates a schematic plane view of an optical sensor module according to a second embodiment of the present invention;

FIG. 4B illustrates a cross sectional view of the optical sensor module as shown in FIG. 4A;

FIG. 5A illustrates a schematic plane view of an optical sensor module according to a third embodiment of the present invention;

FIG. 5B illustrates a cross sectional view taken along line A-B of FIG. 5A;

FIG. 6A illustrates a schematic plane view of an optical sensor module according to a fourth embodiment of the present invention; and

FIG. 6B illustrates a cross sectional view taken along line A′-B′ of FIG. 6A.

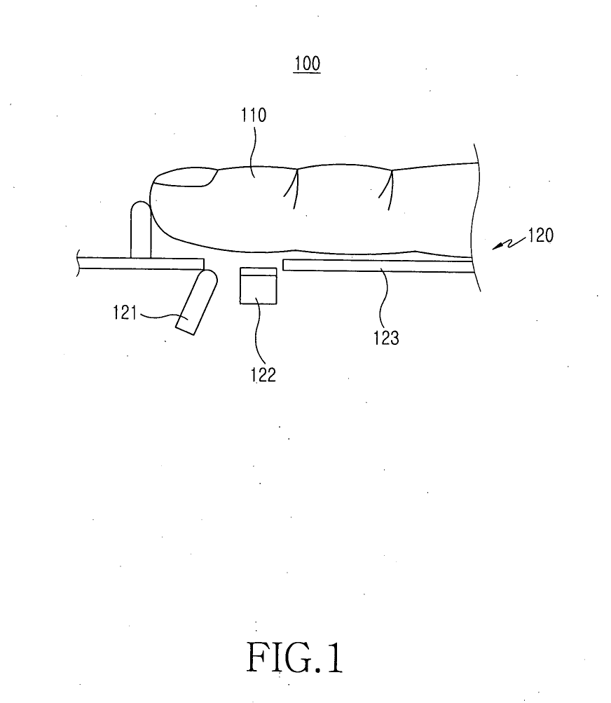

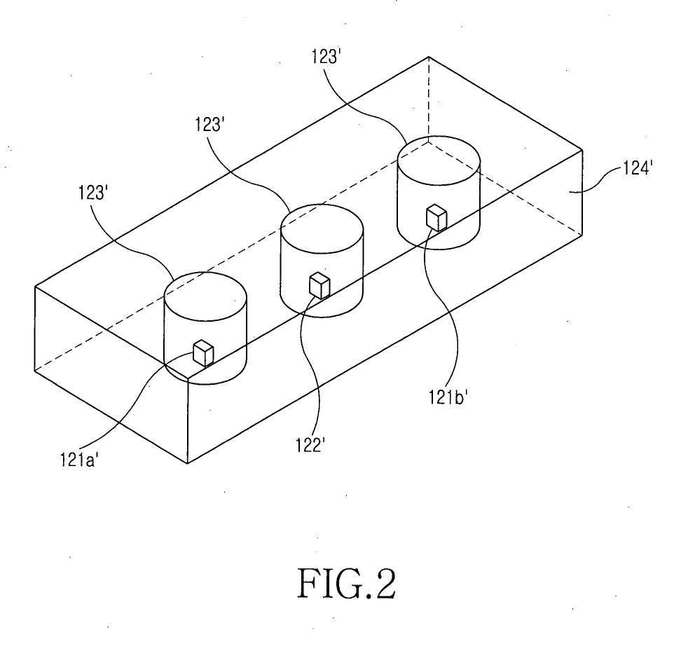

### DETAILED DESCRIPTION OF THE INVENTION

Preferred embodiments of the present invention are described herein below with reference to the accompanying drawings. In the drawings, the same or similar elements are denoted by the same reference numerals even though they are depicted in different drawings. For the purposes of clarity and simplicity, well-known functions or constructions are not described in detail as they would obscure the invention in unnecessary detail.

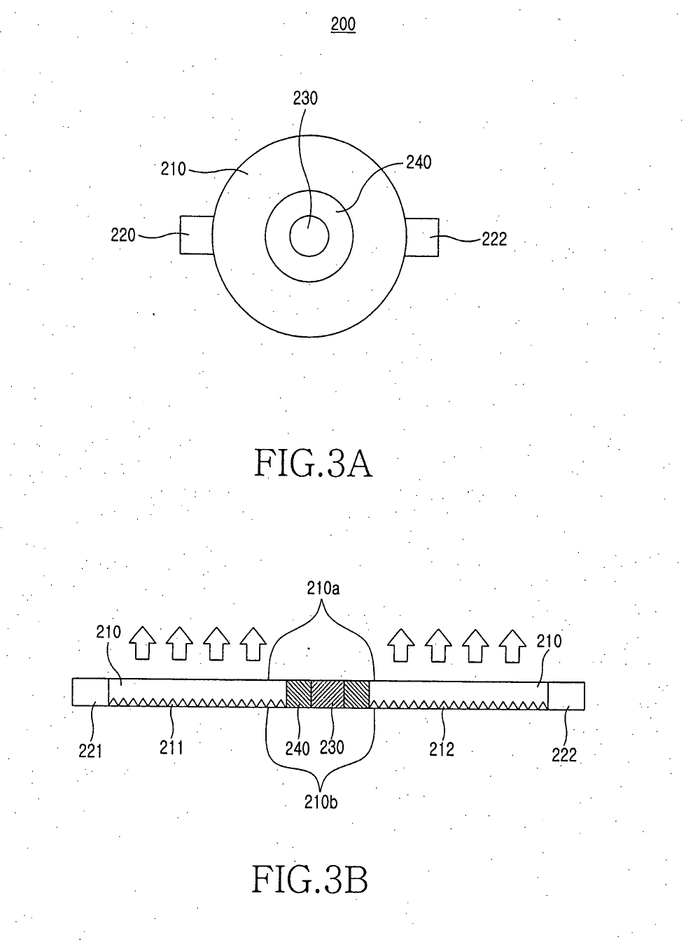

Referring to FIGS. 3A and 3B, an optical sensor module 200 comprises at least a light source 221, 222 for generating a light, an optical sensor 230 for detecting the intensity of a light resulting from the interactance of the light from the light source with organic constituents of a portion of a living body, and a light guide 210 having a first light-transmitting surface 210a contacting the living body portion and a second light-transmitting surface 210b positioned opposite the first surface 210a for dispersing the light from the light sources 221, 222 uniformly across at least a part of the first light-transmitting surface 210a for transmission therethrough into the living body portion, and an optical shield 240 shaped like a ring enclosing the optical sensor. The light sources 221, 222 include an LED (Light Emitting Diode) for generating a light of 600 nm wavelength or a lateral LED.

The optical sensor 230 is inserted in the center of the light guide 210 with a light reception surface exposed, and enclosed by the optical shield 240 for obstructing the light from the light guide 210 from being directly transmitted to the optical sensor 230. The optical sensor 230 measures through the light reception surface the intensity of lights resulting from the interactance of the light from the light sources with the organic constituents of the portion of the living body in contact with the first light-transmitting surface 210a.

At the center of the light guide 210 is mounted the optical sensor 230 enclosed by the optical shield 240, and the second light-transmitting surface 210b is provided with dispersion patterns 211 and 212 for uniformly dispersing the lights from the light sources 221 and 222 mounted on lateral surfaces of the light guide between the first and second light-transmitting surfaces 210a and 210b toward the living body portion. The light guide 210 may be shaped like a ring by extruding a material such as acrylic and polycarbonate capable of transmitting the light of a measuring wavelength. The light entering the light guide 210 undergoes total reflection due to different indexes of refraction, is dispersed by the dispersion patterns 211 and 212 and is guided toward the first light-transmitting surface 210a. In addition, the first light-transmitting surface 210a of the light guide 210 may be preferably provided with a prism sheet (not shown) for adjusting the direction of the light output, and a bottom of the second light-transmitting surface 210b with a reflection sheet (not shown) for reflecting the light leaking through the bottom of the second light-transmitting surface 210b toward the first light-transmitting surface 210a that is in contact with the living body portion.

The structural density of the dispersion patterns 211 and 212 may be adjusted so as to make uniform the lights transmitted from the light sources to the living body portion. In a preferred embodiment, the structural density of the dispersion patterns 211 and 212 is designed to become denser with the distance apart from the light sources 221 and 222, so that the light is dispersed uniformly throughout light guide 210. Namely, both size and density of the dispersion patterns 211 and 212 are determined by at least one of their relative distances from the light sources 221 and 222 and their positions in the light guide 210. The dispersion patterns 211 and 212 may be shaped to have various three-dimensional structures such as cone, hemisphere, hexagon, pyramid, and tetrahedron by subjecting the light guide 210 to a laser or molding process to achieve a surface form engraved or in relief. The dispersion patterns 211 and 212 have both shape and size determined by the length of the light guide 210 and both incident and reflection angles of the light.

The light sources 221 and 222 are arranged on lateral surfaces of the light guide 210 between the first and second light-transmitting surfaces 210a and 210b, generating light that is transmitted into the living body portion. The light waves generated from the light sources 221 and 222 travel through the light guide 210, are reflected by the dispersion patterns 211 and 212 toward the first light-transmitting surface 210a, and then are uniformly transmitted through at least a part of the first life-transmitting surface 210a into the living body portion.

The light transmitted into the living body portion interacts with the organic constituents, is multiply scattered back by the organic constituents so that the light rays resulting from the interactance return to the optical sensor 230. The intensity of the returning light rays varies according to the thickness or percentage of the body fat of the living body portion, so that the ratio of the intensity of a returning light wave to a reference intensity of a light wave originally transmitted into the living body portion is subjected to regression analysis to determine the thickness or percentage of the body fat. The regression analysis depends on the optical sensor, the number of the light wavelengths being used, and may take into consideration the sex, weight, stature, etc. of the subject whose body portion is being measured.

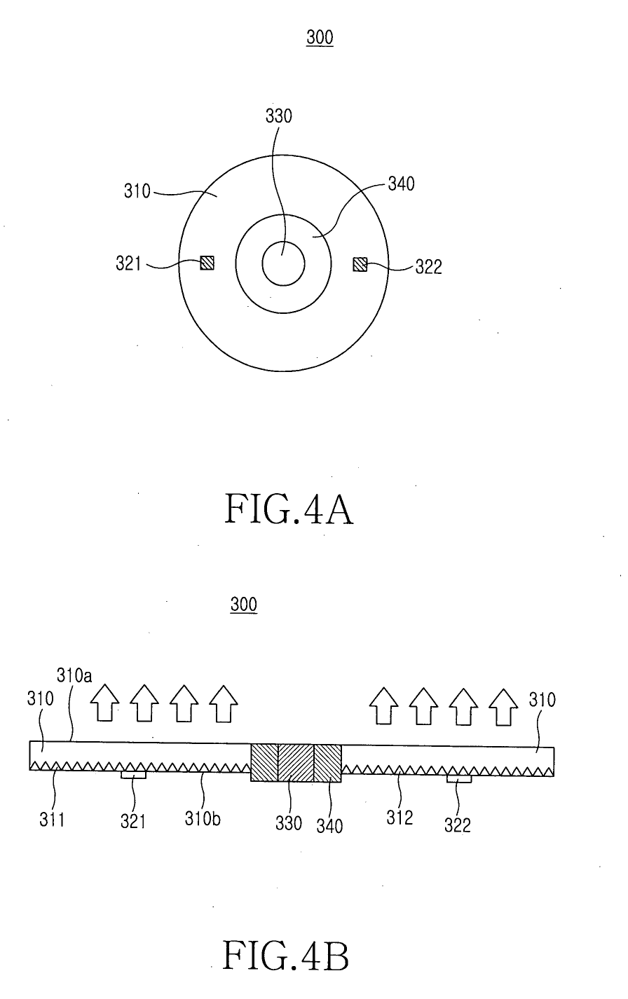

FIGS. 4A and 4B illustrate a second preferred embodiment comprising an optical sensor module 300 that includes light sources 321, 322 for generating a light, an optical sensor 330 for detecting the intensity of a light resulting from the interactance of the light from the light source with organic constituents of a portion of a living body, and a light guide 310 having a first light-transmitting surface 310a contacting the living body portion and a second light-transmitting surface 310b positioned opposite the first light-transmitting surface 310a for transmitting the lights from the light sources 221, 222 uniformly across at least a part of the first light-transmitting surface 310a into the living body portion, and an optical shield 340.

The optical sensor 330 is inserted in the center of the light guide 310 having an exposed a light reception surface, and is enclosed by the optical shield 340 for obstructing the light from the light guide 310 from being directly transmitted to the optical sensor 330. The optical sensor 330 detects, through the light reception surface, the intensity of light resulting from the interactance of the light from the light sources 321 and 322 with the organic constituents of the portion of the living body.

At the center of the light guide 310 is mounted the optical sensor 330 enclosed by the optical shield 340, and the second light-transmitting surface 310b is provided with dispersion patterns 311 and 312 for uniformly dispersing the light from the light sources 321 and 322 toward the portion of the living body. The dispersion patterns 311 and 312 each have a shape and size determined in accordance with the length of the light guide 310 and both incident and reflection angles of the light. The light sources 321 and 322 are mounted on the bottom of the second surface 310b of the light guide 310, sending light toward the dispersion patterns 311 and 312. The light is dispersed by the dispersion patterns 311 and 312 to become a uniform light flux transmitted into the portion of the living body.

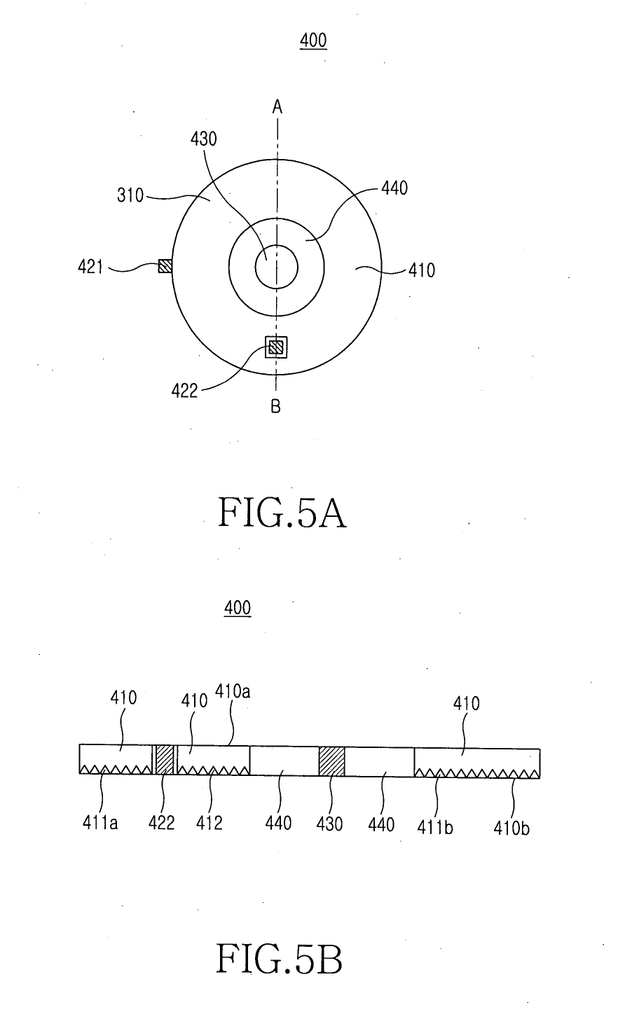

A third preferred embodiment is illustrated in FIGS. 5A and 5B, comprising an optical sensor module 400 that includes a light guide 410 having a first light-transmitting surface 410a for contacting a portion of a living body and a second light-transmitting surface 410b positioned opposite said first light-transmitting surface 410a, a first light source mounted 421 on a lateral surface of said light guide between said first and second light-transmitting surfaces for generating a first light, a second light source for generating a second light 422, an optical sensor 430 inserted in said light guide 410 with a light reception surface exposed to said first surface for measuring the intensities of the light resulting from an interactance of said first 421 and second light 422 with organic constituents of the portion of the living body, and an optical shield 440 for enclosing said optical sensor 430, wherein said second light source 422 is arranged closer to said optical sensor 430 than said first light source 421.

The light guide 410 includes a dispersion pattern 411a, 412 and 411b formed on said second light-transmitting surface 410b for uniformly dispersing said first light and said second light transmitted into said living body

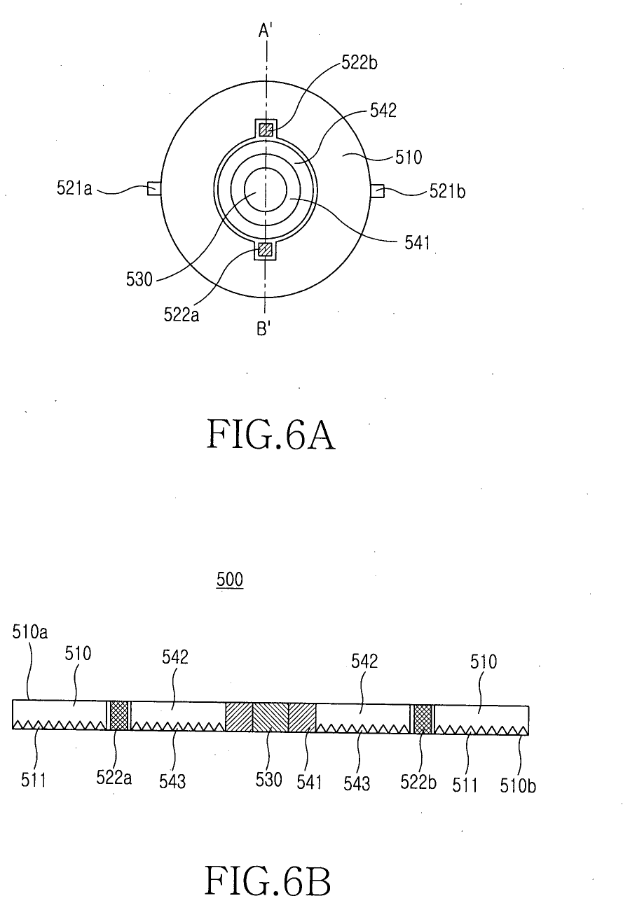

A fourth preferred embodiment is illustrated in FIGS. 6A and 6B, comprising an optical sensor module 500 that includes a first and a second light guide 510 and 542, an optical sensor 530, a pair of first light sources 521a, 521b and a pair of second light sources 522a, 522b, and an optical shield 541 enclosing the optical sensor 530.

The pair of first light sources 521a and 521b generate first light for measuring organic constituents, such as the body fat of a living body, and are symmetrically arranged on a side of the first light guide 510 that is configured around the optical sensor 530. The second light sources 522a and 522b generate second light for detecting a signal relating to the pulse of a living body, and are symmetrically arranged in the first light guide 510 that is configured to surround the optical sensor 530. The second light sources 522a and 522b are arranged to be closer to the optical sensor 530 than the first light sources 521a and 521b. The first and second light sources 521a, 521b, 522a, 522b may employ a type selected from LED and lateral LED capable of generating a wavelength of 600 nm or more and lateral LED capable of generating a wavelength of 600 nm or more.

The first light guide 510 is arranged to enclose the second light guide 542, and guides the first light, dispersed uniformly by the dispersion pattern 511 mounted on a second light-transmitting surface 510b, to a first light-transmitting surface 510a. The second light guide 542 has a side provided with the second light sources 522a and 522b and transmits the second light uniformly dispersed by the dispersion pattern 543 into the portion of the living body. At the center of the second light guide 542 is arranged the optical sensor 530 having a light reception surface exposed, said second light guide being enclosed by an optical shield 541.

Thus, the inventive optical sensor module of preferred embodiment of the present invention transmits the measuring light uniformly dispersed by the light guide into the living body, so that it is not required to make the length of the module larger than the diameter, thereby considerably reducing its volume.

While the invention has been shown and described with reference to a certain preferred embodiment thereof, it will be understood by those skilled in the art that various changes may be made therein without departing from the spirit and scope of the invention as recited by the appended claims.

What is claimed is:

1. An optical sensor module for measuring organic constituents of a portion of a living body, comprising:
at least one light source to output a light;
an optical sensor having a light reception surface to measure the intensity of a light resulting from the interactance with said organic constituents of said light output by said at least one light source; and
a light guide having a first light-transmitting surface to contact the living body portion and a second light-transmitting surface positioned opposite said first light-transmitting surface, said light guide to distribute the light output by said light source uniformly across at least a part of said first light-transmitting surface for transmission therethrough into the portion of the living body, the light reception surface of said optical sensor configured to be exposed to said first light-transmitting surface.

2. An optical sensor module as defined in claim 1, wherein said light guide includes a dispersion pattern formed on said second light-transmitting surface whereby the light from said light source transmitted toward said first light-transmitting surface is uniformly dispersed.

3. An optical sensor module as defined in claim 2, wherein said light source is arranged on a lateral surface of said light guide between said first and second surfaces.

4. An optical sensor module as defined in claim 1, further including an optical shield arranged between said light guide and said optical sensor to obstruct passage of light therebetween.

5. An optical sensor module as defined in claim 1, wherein said light guide is made of a material for transmitting the light of a measuring wavelength band.

6. An optical sensor module as defined in claim 1, wherein said light source includes an LED (Light Emitting Diode) for generating a light of 600 nm wavelength.

7. An optical sensor module as defined in claim 1, wherein said light source includes a lateral LED.

8. An optical sensor module as defined in claim 2, wherein the light entering said light guide undergoes total reflection due to different indexes of refraction.

9. An optical sensor module as defined in claim 2, wherein said dispersion pattern shape is selected from the group consisting of cone, hemisphere, hexagon, pyramid, and tetrahedron.

10. An optical sensor module as defined in claim 2, wherein said dispersion pattern is formed using a technique selected from the group consisting of engraving and relief.

11. An optical sensor module as defined in claim 2, wherein both a size and a density of said dispersion pattern are determined by at least one of a relative distance of the dispersion pattern from said light source and a position of the dispersion pattern in said light guide.

12. An optical sensor module as defined in claim 1, wherein said light guide is shaped like a ring.

13. An optical sensor module as defined in claim 4, wherein said optical shield is shaped like a ring enclosing said optical sensor.

14. An optical sensor module for measuring organic constituents of a portion of a living body, comprising:
at least one light source to output a light;
an optical sensor having a light reception surface to measure the intensity of a light resulting from the interactance with said organic constituents of said light output from said light source; and
a light guide having a first surface to contact the portion of the living body and a second surface positioned opposite said first surface, said light guide to distribute the light output by said light source uniformly across at least a part of said first surface into the portion of the living body portion, the light reception surface of said optical sensor configured to be exposed to said first surface, wherein said light source is arranged on said second surface, and said optical sensor is inserted in said light guide such that said light reception surface of said optical sensor is exposed to said first surface of said light guide.

15. An optical sensor module as defined in claim 14, further including an optical shield arranged between said light guide and said optical sensor to obstruct passage of light therebetween.

16. An optical sensor module for measuring organic constituents of a portion of a living body, comprising:
a light guide having a first light-transmitting surface to contact the portion of the living body and a second light-transmitting surface positioned opposite said first surface;
a first light source mounted on a lateral surface of said light guide between said first and second surfaces for generating a first light such that said first light passes through said first and second light-transmitting surfaces;
a second light source for generating a second light such that said second light passes through said first and second light-transmitting surfaces;
an optical sensor inserted in said light guide having a light reception surface exposed to said first light-transmitting surface to measure the intensities of a light resulting from an interactance of said first and second light with said organic constituents, wherein said optical sensor is arranged closer to said second light source than to said first light source; and
an optical shield to partially enclose said optical sensor to obstruct passage of light between said light guide and said optical sensor except through said first light-transmitting surface.

17. An optical sensor module as defined in claim 16, wherein said light guide includes a dispersion pattern formed on said second surface to uniformly disperse said first light and said second light transmitted into said portion of said living body.

18. An optical sensor module for measuring organic constituents of a portion of a living body, comprising:
a first light guide;
a first light source arranged on a lateral surface of said first light guide for generating a first light;
a second light guide enclosed by said first light guide;
a second light source arranged between said first light guide and said second light guide for generating a second light supplied to said second light guide; and
an optical sensor inserted in said second light guide having a light reception surface to contact said portion of said living body to measure the intensities of the light resulting from the interactance of said first and second light with said organic constituents.

19. An optical sensor module as defined in claim 18, further including an optical shield for enclosing said optical sensor.

20. An optical sensor module as defined in claim 18, wherein said first light guide and said second light guide include a respective first and second dispersion pattern to uniformly disperse the first light and the second light.
